(19) United States
(12) Patent Application Publication
(10) Pub. No.: US 2010/0082428 A1
(43) Pub. Date: Apr. 1, 2010

(54) DISPLAY ADVERTISING INVENTORY ESTIMATION

(75) Inventors: Sergei Vassilvitskii, New York, NY (US); Jayavel Shanmugasundaram, Santa Clara, CA (US); Srinivasan Rajagopal, San Jose, CA (US); Minos Garofalakis, Chania (GR); Erik N. Vee, San Mateo, CA (US); Ramana Yerneni, Cupertino, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/242,709

(22) Filed: Sep. 30, 2008

(51) Int. Cl. G06Q 30/00; G06Q 10/00; G06Q 20/00

(52) U.S. Cl. 705/14.49; 705/28; 705/400; 705/14.58

(57) ABSTRACT

Example embodiments described herein may relate to estimating inventory for a display advertising system utilized, for example, in Web-based advertising.

### FIELD

Subject matter disclosed herein may relate to estimating inventory for a display advertising system utilized, for example, in Web-based advertising.

### BACKGROUND

With networks such as the Internet gaining tremendous popularity and with the vast multitude of pages and/or other documents and/or other media content becoming available to users via the World Wide Web (web), for example, Web-based display advertising has increased in importance and prominence as industry seeks to take better advantage of the opportunities potentially afforded by these networks, including the Internet. In Web-based advertising systems, advertisements may be embedded in web pages that may be accessed by users via web browser applications executed on any of a number of electronic device types. In such systems, it may be advantageous to present particular advertisements to particular users or types of users.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a block diagram of an example embodiment of a display advertising system;

FIG. 2 is a block diagram of an example embodiment of a display advertising system including inventory estimation;

FIG. 3 is a block diagram of an example embodiment of a display advertising platform;

FIG. 4 is a flow diagram of an example embodiment of a method for determining a capability to fulfill a display advertising contract; and

FIG. 5 is a block diagram illustrating an example system comprising a plurality of computing devices coupled via a network in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

Likewise, the terms, “and,” “and/or,” and “or” as used herein may include a variety of meanings that also is expected to depend at least in part upon the context in which such terms are used. Typically, “or” as well as “and/or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description which follow are presented in terms of algorithms or symbolic representations of operations on data bits or binary digital signals stored within a computing platform memory, such as a computer memory. These algorithmic descriptions or representations are examples of techniques used by those of ordinary skill in the data processing arts to convey the substance of their work to others skilled in the art. An algorithm here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform. Further, unless specifically stated otherwise, processes described herein, with reference to flow diagrams or otherwise, may also be executed and/or controlled, in whole or in part, by such a computing platform.

As discussed above, in Web-based advertising systems, advertisements (“ads”) may be embedded in web pages that may be accessed over the Internet by users via web browser applications executed on any of a number of electronic device types. Such network-based advertising may be referred to as “display advertising.” In display advertising systems, ads may include text or graphical information such as logos, photographs, or other images, for example. Ads may provide links to other web sites so that if a user clicks on or otherwise selects an ad, the user may be directed to a web site associated with the ad. Ads may further include any of a wide range of digital content types, including, but not limited to, text, static images, video, or audio elements. However, these are merely examples of possible types of display advertisements, and the scope of claimed subject matter is not limited in these respects.

As also mentioned above, it may be advantageous in some circumstances for an advertiser to present particular advertisements to particular users or types of users. For example, an advertiser may wish to target an ad at men in particular, and may therefore specify to a web page publisher to display the ad whenever particular web pages thought to be of interest to men are accessed. For example, an advertiser for shaving products may think it advantageous to target an ad at men, and may specify that the ad be displayed whenever a page related to “sports” is accessed. Similarly, for another example, an advertiser for cosmetics may think it advantageous to target a particular ad at women specifically, and may specify that the ad be displayed whenever a page related to women's clothing is accessed.

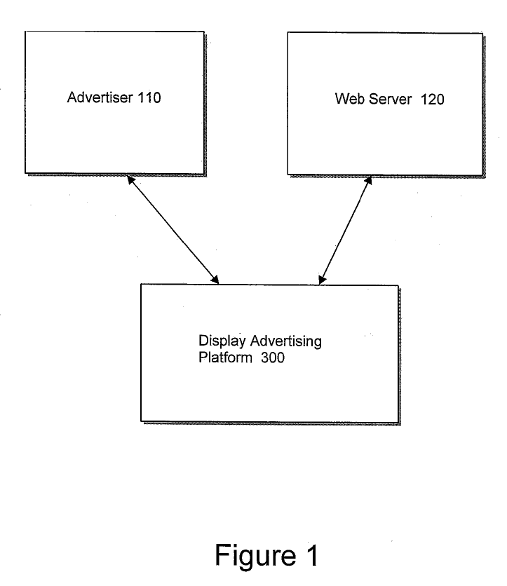

FIG. 1 is a block diagram of an example embodiment of a display advertising system. For an embodiment, an advertiser 110 may desire to place one or more ads on a web server 120 to be seen by a plurality of users that may access one or more web pages via the server. A display advertising platform 300 may receive contract requests from advertiser 110, and may determine whether adequate inventory exists to satisfy the contract. For an embodiment, a contract request may specify one or more ads to be displayed, and may specify any of a range of conditions surrounding the displaying of the ad, including, but not limited to, the number of times the ad is to be displayed and the time period over which the ad is to be displayed. As is discussed below, the contract request may also specify that the ad be displayed to particular types of users based, at least in part, on one or more demographic attributes, for example. In the context of a display advertising system, “inventory” may relate to the number of “impressions” that may be projected or estimated to be available to satisfy the contract. As used herein, the term “impression” is meant to denote an access of a web page or other digital object over a network such as the Internet by a user by way of any of a wide range digital electronic device types. The term “impression” may further relate to information associated with the user and/or with the accessed web page. Example types of information that may make up, at least in part, an impression and that may be associated the user or with the web page are discussed more fully below. Further, as used herein the term “stored impression” is meant to include information related to an impression stored in a storage medium in a computing platform. Such stored impression information may be gleaned from information gathered from user accesses to one or more web sites, for one example embodiment, as more fully discussed below. Impressions may also be generated, for an example embodiment, by a forecasting engine or other system element based, at least in part, on one or more mathematical models, thereby reducing or eliminating the storage of impressions. Stored and/or generated impressions may be used, in one or more embodiments, to analyze any of a range of issues related to demand forecasting or inventory availability associated with display advertising platforms.

If display advertising platform 300 determines that sufficient inventory will be available to satisfy the terms of the contract request, the contract may be accepted, or booked. Display advertising platform 300 may track booked contracts and may also track projected inventory availability so that newly received contract requests may be evaluated and available inventory may be determined. Display advertising platform 300 may provide an appropriate advertisement at least in part in accordance with the term of the booked contract to web server 120, and if a user access, or impression, to a web site on web server 120 is determined to match the terms of the booked contract, web server 120 may display the advertisement to the user.

As mentioned above, it may be advantageous to target advertisements more narrowly by targeting particular ads to particular desired demographic groups. Display advertising platform 300 may collect information related to users as the users browse around the web server's web pages, and such information may be collected and/or stored in a database. For an embodiment, the database may comprise a scalable multi-dimensional database with a bit-mapped indexing technique. The stored information may be utilized in some cases to identify particular users and/or user computing platforms and to gather information related to that user, perhaps by analyzing the user's browsing behavior. For example, if the user, perhaps identified by some sort of user identification (user ID), is observed to access a sports site, or is observed to access web pages related to men's clothing, the web page publisher may assume that the user associated with that particular ID is male. In some cases, web page publishers may gather information related to users by explicitly asking the users to provide the information, perhaps as part of a registration process.

Whether obtained by the user directly, or obtained through observation and analysis of the user's browsing behaviors, web page publishers and/or display advertising providers may store a range of information related to the users. For one or more embodiments, the stored information may be organized at least in part as one or more stored impressions. Examples of the types of information that may be associated with a user may include, but are not limited to, user ID, Internet Protocol (IP) address, name, gender, age, country, state/province and/or city of residence, subject areas of interest to the user, income level, occupation, birth date, education level, language, etc. Of course, these are merely examples of the types of information that may be associated with a user, and the scope of claimed subject matter is not limited in this respect. Also, as mentioned above, impressions may be generated by a forecasting engine or other system element, for one or more embodiments. Such generated impressions may comprise similar types of information as that of stored impressions, discussed above. The generated impressions may be based, at least in part, on mathematical models that may attempt to create impressions that may approximate, at least in part, impressions formed from actual user accesses to web pages.

As previously described, the term “impression” is meant to denote an access of a web page by a user. The term “impression” may further relate to information associated with the user and/or with the accessed web page. Example information types are mentioned above, although the scope of claimed subject matter is not limited in these respects. An impression may further be thought of as a customized advertising “opportunity”. If a user accesses a web page located on web server 120, which may happen millions of time a day in some cases, there may exist one or more opportunities to display one or more advertisements. The opportunities may be customized by analyzing or identifying demographic characteristics or target attributes of the users accessing the web pages, and decisions may be made with regard to which advertisements, if any, to display to the users by embedding the advertisements in the accessed web page. Advertisers may contract with web page publishers to show particular ads to specified categories of users a specified number of times over a specified period of time, for one or more embodiments, for example.

For one or more embodiments, display advertising platform 300 may track booked contracts and may also track projected inventory so that newly received contract requests may be evaluated and decisions can bee made with regard to capabilities to fulfill the contract request. For an embodiment, display advertising platform 300 may store information for a number of impressions. For another embodiment, a number of impressions may be generated from mathematical models, as mentioned previously. The stored and/or generated impressions may be analyzed in conjunction with future demand information gleaned from previously booked contracts to determine available future inventory. However, the issue of determining available inventory may become relatively complex for systems serving relatively large numbers of impressions with potentially wide ranges of demographic attributes for the impressions.

Further, individual impressions may be able to satisfy, at least in part, more than one contract in many cases. For example, an impression may include attributes identifying a particular user as being male and also as residing in California. Thus this impression may be applied to contracts with a target attribute specifying that a particular ad be displayed to a number of Californians, or may also be applied to a contract with a target attribute that specifies that an ad be displayed to a number of males. For some embodiments, hundreds or thousands of different, overlapping targeting attributes in a high-dimensional targeting space may potentially need to be managed because different advertisers may specify different overlapping targeting combinations, and it may be advantageous to ensure that sufficient inventory exists to satisfy all previously accepted, and in some cases guaranteed, contracts.

For one relatively simple example, consider a case where display advertising platform 300 estimates an available inventory comprising a total of 2,000 impressions. For this example, assume that a previous contract has been received specifying that an ad be displayed to 1,000 males. Also for this example, a new contract request may be received specifying that another ad be displayed to 1,000 Californians. If the 2,000 impressions that make up the available inventory include 1,000 males and 1,000 Californians with no overlap between the males and the Californians, it may be determined that the display advertising platform is capable of satisfying the new contract request. However, if it is determined that the set of impressions representing the 1,000 Californians includes, for example, 500 males, the intersection between “males” and “Californians” may be determined to be 500, and there would be insufficient inventory to satisfy the previously booked contract and the new contract, because to satisfy the previously booked contract would mean to use 500 of the 1,000 impressions representing “Californians”. Thus, it may be seen from this simple example the importance of tracking and determining intersections between contracts to determine whether sufficient inventory exists to satisfy a contact request.

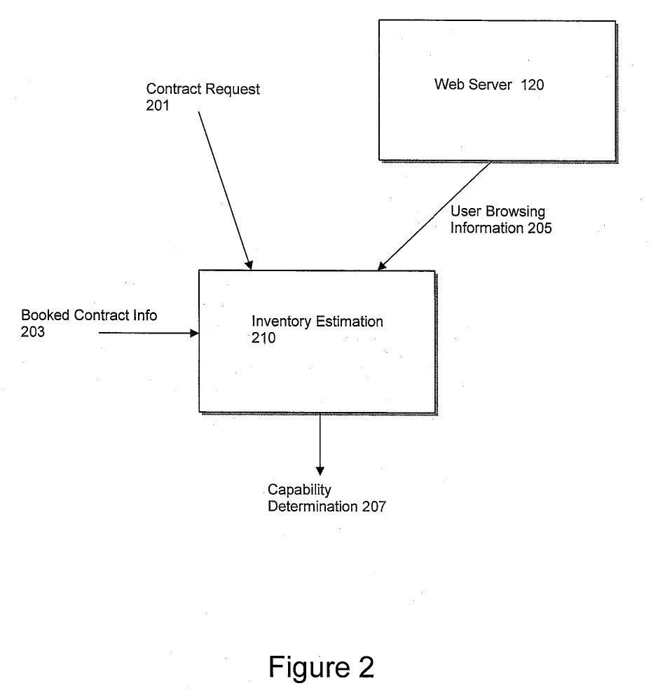

FIG. 2 is an example embodiment of a display advertising system including an inventory estimation element 210. For one or more embodiments, if a contract request 201 is received, a set of stored and/or generated impressions matching the contract request may be analyzed. An impression may be considered to “match” the contract request if the target attributes specified in the contract request matches the target attributes of the impression. For an embodiment, the set of impressions may comprise a plurality of impressions stored in the system of otherwise available to the system that match the contract request. For an embodiment, the plurality of impressions may comprise relatively large numbers of impressions, perhaps including every impression that matches the contract request. However, the computational costs incurred if using a set comprising every impression matching the contract request may be prohibitive. To reduce computational costs, and to increase the speed and efficiency in which calculations may be made, a “sample” of impressions may be used for one or more embodiments. Inventory estimations may be extrapolated from the results obtained through analysis of the sampled impressions, for an embodiment. Consider the following example. For this example, assume that inventory estimation element 210 has stored thereon 100,000 impressions gleaned from user browsing information 205 related to a plurality of user accesses to web server 120. Also for this example, contract request 201 may specify, among other things, that an ad be displayed over a period of time to 250,000 users with the target attribute of “male.” Rather than analyzing every stored impression that matches the target attribute of “male”, or rather than generating relatively very large numbers of impressions that match the attribute “male” from mathematical models, inventory estimation element 210 may sample a smaller number of impressions and perform inventory estimation operations based at least in part on the analysis of the sampled impressions. For the present example, inventory estimation element 210 may sample 500 impressions and may extrapolate inventory availability estimations based, at least in part, on the analyses performed using the sampled impressions. Of course, the numbers of stored impressions and sampled impressions mentioned in connection with the examples herein are merely examples, and the scope of claimed subject matter is not limited in these respects.

The estimates of future inventory may comprise estimates related to the number of impressions expected to be received over a period of time, and also may comprise information related to the expected demographic attributes for those impressions. The sampled impressions may be analyzed in conjunction with future demand information gleaned from booked contract information 203, that is, information related to previously booked contracts, to estimate the possible available future inventory. A capability determination 207 may be communicated to a computing platform or perhaps to a sales agent, for one or more embodiments.

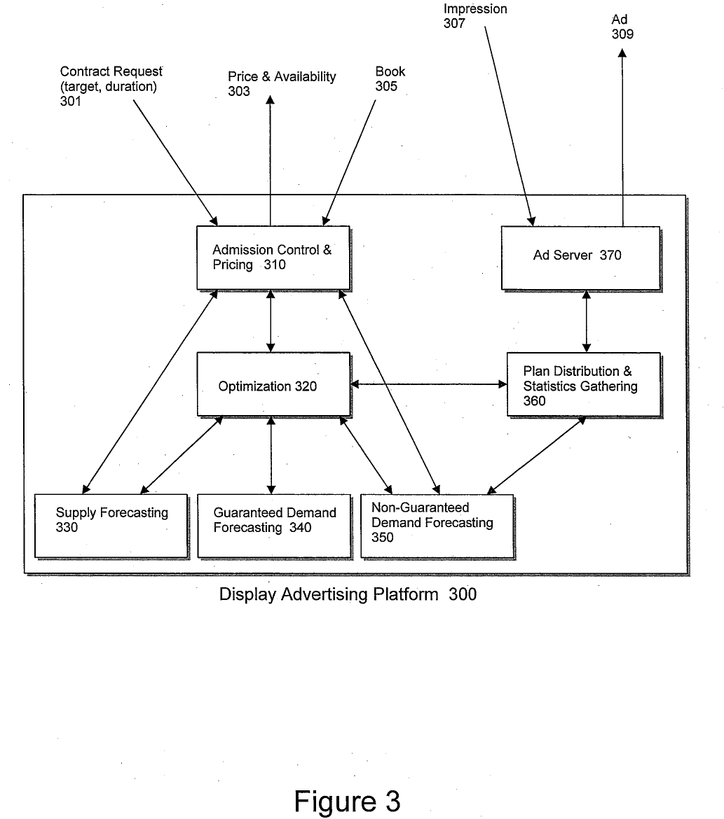

FIG. 3 is a block diagram depicting an example embodiment of display advertising platform 300. For one or more embodiments, a contact request 301 may be received at display advertising platform 300. An admission control and pricing unit 310 may provide pricing and availability information 303 to a sales agent, for example, or perhaps to an advertiser, and may also receive a contract booking 305 if the agent agrees to pricing and availability information, for an embodiment. If the contract is booked, an ad server 370 may provide an ad 309 to web server 120 based, at least in part, on impression information 307 provided, for an embodiment, by web server 120. Impression 307 may comprise one or more target attributes that may be used by ad server 370 to determine the appropriate ad to provide to web server 120 for display to a user matching the target attributes.

Although not depicted in FIG. 3, for another embodiment, ad server 370 may receive the impression 307 from an exchange system that may receive bids from one or more potential advertisers, and the exchange system may auction the impression off to one of the advertisers, who would deliver the ad to the displayed to the exchange system for delivery to the web server for display to a user matching the target attributes of the impression. In this manner, display advertising platform 300 may operate as merely one of perhaps two or more bidders for advertising over the exchange system. However, for the example depicted in FIG. 3, and for the examples described below, it may be assumed that ad server 370 is not communicating with the web server through an exchange, and that display advertising platform 300 is the only advertiser placing ads on web server 120. Of course, this is merely one example embodiment of a display advertising system, and the scope of claimed subject matter is not limited in this respect.

For the example embodiment depicted in FIG. 3, admission control and pricing unit 310 may receive contract request 301 from a sales agent, perhaps, or in another embodiment from an advertiser directly, although the scope of claimed subject matter is not limited in these respect. For an embodiment, contract request 301 may comprise one or more target attributes, and may also comprise a duration for the contract. Also, the contract may, for an embodiment, specify an number of times over the course of the duration of the contract that a specified advertisement is to be displayed to users matching the target attributes. Admission control and pricing unit 310 may also track the amount of inventory in the form of impressions that have already been reserved by previously booked contracts, and may also determine whether sufficient inventory exists to satisfy the terms of contract 301. For an embodiment, admission control and pricing unit 310 may also determine a price for the contract request, and may communicate the price and availability 303 to the sales agent or to the advertiser. The sales agent or advertisement may communicate an acceptance of the pricing and availability information 303 via contract booking information 305.

For one or more embodiments, display advertising platform 300 may comprise a supply forecasting unit 330 that may determine what inventory may be available in the future. The types and amounts of impressions that may be available looking forward may be based, at least in part, on the types and amounts of impressions observed in the past. For-an embodiment, supply forecasting unit 330 may store a number of impressions for use in inventory availability determination operations, for example. For another embodiment, supply forecasting unit 330 may generate samples based, at least in part, on mathematical models. The models used may be selected based on observed, predicted, or desired impression attributes, and the scope of claimed subject matter is not limited to any particular mathematical model in generating impressions.

Admission control and pricing unit 310 may query supply forecasting unit 330 to obtain sets of samples of impressions from which determinations may be made regarding estimated inventory availability along with information from previously booked contracts, as describe above in connection with FIGS. 1 and 2. Admission control and pricing unit 310 may comprise an inventory estimation element, such as, for an embodiment, inventory estimation element 210, depicted in FIG. 2. Also, one or more lists of booked contracts may be maintained, in one or more embodiments, by admission control and pricing unit 310, although the scope of claimed subject matter is not limited in this respect.

For one or more embodiments, display advertising platform 300 may also include a guaranteed demand forecasting unit 340 that may forecast the demand for guaranteed inventory. In short, for one or more embodiments, guaranteed demand forecasting unit 340 seeks to estimate the amount of different contract types to expect looking forward. For one or more embodiments, whenever an advertiser or sales agent submits a contract request, the advertiser may specify guaranteed service of a specified number and type of impressions, or the advertiser may select perhaps lesser quality impressions, that is, impressions that might not be as specifically targeted as might otherwise be the case with guaranteed inventory, or the advertiser may select non-guaranteed amounts of impressions in exchange for lower pricing. If a display advertising platform is to accept contract requests for both guaranteed and non-guaranteed inventory, it may be advantageous to estimate the future demand for guaranteed inventory in order to help ensure that the more valuable, or high demand, inventory is not sold to quickly or at too low a cost. For example, guaranteed demand forecasting unit 340 may observe that in the past, a number of contracts specified guaranteed impressions identifying particular financial web sites, for example, and it may be expected that more contract requests may be expected that specify target attributes identifying the financial web pages. Admission control and pricing unit 310 may base its pricing decisions at least in part on the information from guaranteed demand forecasting unit 310.

Also for an embodiment, display advertising platform 300 may comprise non-guaranteed demand forecasting unit 350. For the present embodiment, non-guaranteed demand forecasting unit 350 may determine or estimate a future demand for non-guaranteed inventory. As mentioned previously, non-guaranteed inventory may be lower cost than guaranteed inventory, and may be of a lower quality in that the advertiser may not be able to as specifically target particular demographic categories or may not receive guarantees as to the amount of impressions to be serviced.

Also included in display advertising platform 300 for this embodiment is optimization unit 320. In general, optimization unit 320 may determine an approximate or estimated “optimal” plan of action based on one or more business goals and/or what the various units estimate will happen in the future. Optimization unit 320 may provide information to admission control and pricing unit 310 and to a plan distribution and statistics gathering unit 360, for one or more embodiments. Plan distribution and statistics gathering unit 360 may communicate optimization information to ad server 370, and may also track information communicated by ad server 370 such as, for example, impression information and information related to which ads have been displayed, for example.

As described above, admission control and pricing unit 310 may maintain a list of previously booked contracts. If a new contract request such as contract request 301 is received, a set of samples for the contract request may be obtained from supply forecasting unit 330. For the sample impressions, individual determinations may be made with regard to which of the previously booked contracts may be satisfied by the impression to estimate intersection sizes and to determine any overlap among the new contract request and the previously booked contracts. For merely one simple example, assume that a previous contract booked 1,000,000 impressions with the attribute “male”. Also for this example, assume that a new contract request comprises a target attribute of “Californian”. For an embodiment, 100 impressions of “Californians” may be sampled. In analyzing the samples, it may be determined, for this example, that the set of 100 Californians includes 52 males. If supply forecasting unit 330 reports a total estimated available inventory of 3,000,000 males, it may be estimated that the 3,000,000 impressions with the attribute “male” may include 1,560,000 impression that also share the attribute “Californian”. In this manner, the intersection sizes may be estimated, and admission control and pricing unit 310 may determine whether the new contract may be accommodated. Of course, the numbers and types of impressions described in this example are merely examples, and the scope of claimed subject matter is not limited in these respects.

As described above, for one or more embodiments, supply forecasting unit 330 may provide admission control and pricing unit 310 sets of sampled impressions for use in inventory estimation and/or determination operations. For various embodiments, any of a number of techniques may be used for the sampling of impressions. For one example, samples matching a specified target attribute may be chosen with equal probability. In this case, all of the samples have the same weight, which reflects the total number of available impressions. For another example, samples may be taken from a set of representative impressions, perhaps pre-computed or generated and stored, and the impressions may be given a weight. Samples matching the specified target attribute may be chosen from the set of representative impressions with a probability proportional to the weight of the impression. In this example, the samples again have the same weight, which may reflect the total number of available impressions. Alternatively, the samples may be chosen with equal probability, in which case the weight of the samples are proportional to the weight of the representative impression.

In an additional example embodiment, sample impressions matching the specified target attribute may be selected with a probability related to the number and/or importance of contracts for which the impression is eligible. The impressions may receive weightings that are inversely proportional to the expected number of times they are sampled. Similarly, for another example, other techniques for determining and quantifying the importance of an impression may be utilized, and as with the previous example, impressions matching the specified target attribute may be selected with a probability related to the importance of those impressions. Again, the sampled impressions may receive a weight that is inversely proportional to the expected number of time it is sampled. Of course, the techniques described herein for sampling impressions are merely examples, and the scope of claimed subject matter is not limited in these respects.

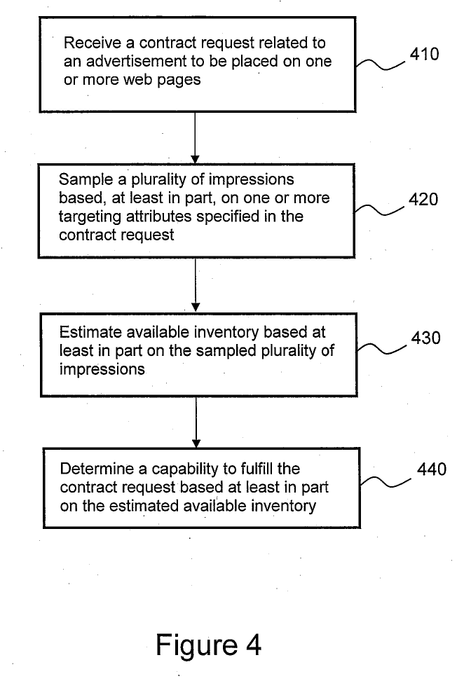

FIG. 4 is a flow diagram of an example embodiment of a method for estimating available inventory for a display advertising system. At block 410, a contract request may be received, wherein the contract request is related to an advertisement to be placed on one or more web pages. At block 420, a plurality of impressions may be sampled based, at least in part, on one or more targeting attributes specified in the contract request. An estimate of available inventory may be estimated based, at least in part, on the sampled plurality of impressions at block 430, and at block 440 a capability to fulfill the contract request may be determined. The determination may be based, at least in part, on the estimated available inventory. Embodiments in accordance with claimed subject matter may include all, more than, or less than, blocks 410 through 440. Also, the order of blocks 410-440 is merely an example order, and the scope of claimed subject matter is not limited in this respect.

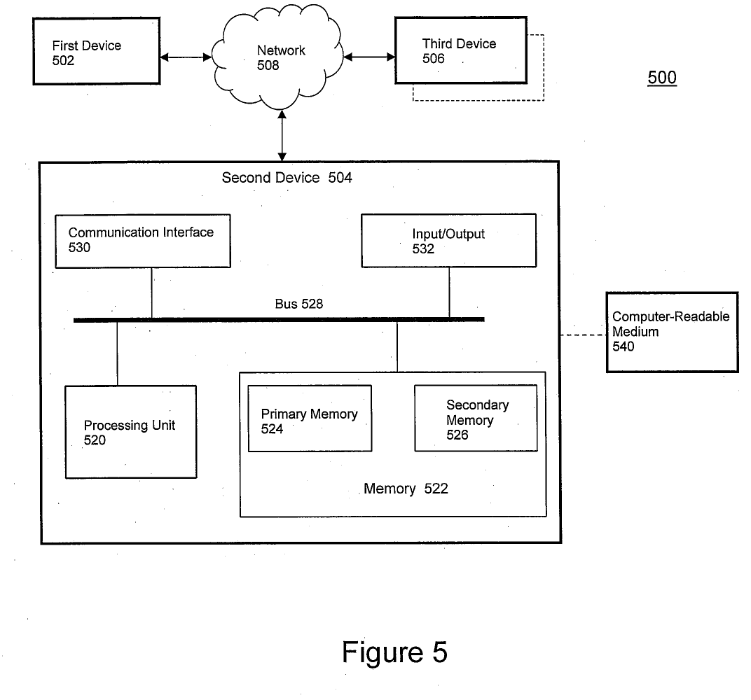

FIG. 5 is a schematic diagram illustrating an exemplary embodiment of a computing environment system 500 that may include one or more devices configurable to implement techniques and/or processes described above, for example, in connection with example embodiments of display advertising platforms and systems depicted in FIGS. 1-4. System 500 may include, for example, a first device 502, a second device 504, and a third device 506, which may be operatively coupled together through a network 508.

First device 502, second device 504 and third device 506, as shown in FIG. 5, may be representative of any device, appliance or machine that may be configurable to exchange data over network 508. By way of example but not limitation, any of first device 502, second device 504, or third device 506 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof. Any of the first, second, and third devices 502, 504, and 506, respectively, may comprise one or more of a web page publisher, ad server, display advertising platform, user computing platform, and/or a mobile device in accordance with the example embodiments described herein.

Similarly, network 508, as shown in FIG. 5, is representative of one or more communication links, processes, and/or resources configurable to support the exchange of data between at least two of first device 502, second device 504, and third device 506. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof. As illustrated, for example, by the dashed lined box illustrated as being partially obscured of third device 506, there may be additional like devices operatively coupled to network 508.

It is recognized that all or part of the various devices and networks shown in system 500, and the processes and methods as further described herein, may be implemented using or otherwise include hardware, firmware, software, or any combination thereof.

Thus, by way of example but not limitation, second device 504 may include at least one processing unit 520 that is operatively coupled to a memory 522 through a bus 528.

Processing unit 520 is representative of one or more circuits configurable to perform at least a portion of a data computing procedure or process. By way of example but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 is representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 540. Computer-readable medium 540 may include, for example, any medium that can carry and/or make accessible data, code and/or instructions for one or more of the devices in system 500. Computer readable medium 540 may also be referred to as a storage medium.

Second device 504 may include, for example, a communication interface 530 that provides for or otherwise supports the operative coupling of second device 504 to at least network 508. By way of example but not limitation, communication interface 530 may include a network interface device or card, a modem, a router, a switch, a transceiver, and the like.

Second device 504 may include, for example, an input/output 532. Input/output 532 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 532 may include an operatively configured display, speaker, keyboard, mouse, trackball, touch screen, data port, etc.

Embodiments claimed may include one or more apparatuses for performing the operations herein. These apparatuses may be specially constructed for the desired purposes, or they may comprise a general purpose computing platform selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the descriptions herein.

Embodiments disclosed herein may be implemented in hardware, such as implemented to operate on a device or combination of devices, whereas another embodiment may be implemented in software. Likewise, an embodiment may be implemented in firmware, or as any combination of hardware, software, and/or firmware, for example.

Likewise, although the scope of claimed subject matter is not limited in this respect, one embodiment may comprise one or more articles, such as a storage medium or storage media. This storage media may have stored thereon instructions that if executed by a computing platform, such as a computer, a computing system, an electronic computing device, a cellular phone, a personal digital assistant, and/or other information handling system, for example, may result in an embodiment of a method in accordance with claimed subject matter being executed, for example. The terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks, floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of claimed subject matter is not limited in this respect.

The term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set that includes the encoded commands. Such an instruction may be encoded in the form of a machine language understood by the processor. For an embodiment, instructions may comprise run-time objects, such as, for example, Java and/or Javascript and/or PHP objects. However, these are merely examples of an instruction, and the scope of claimed subject matter is not limited in this respect.

It should also be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Such software and/or firmware may be expressed as machine-readable instructions which are executable by a processor. Likewise, although the claimed subject matter is not limited in scope in this respect, one embodiment may comprise one or more articles, such as a storage medium or storage media. This storage media, such as one or more CD-ROMs and/or disks, for example, may have stored thereon instructions, that when executed by a system, such as a computer system, computing platform, or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A method, comprising:
receiving a contract request related to an advertisement to be placed on one or more web pages;
sampling a plurality of impressions based, at least in part, on one or more targeting attributes specified in the contract request;
estimating available inventory based at least in part on the sampled plurality of impressions; and
determining a capability to fulfill the contract request based at least in part on the estimated available inventory.

2. The method of claim 1, wherein the one or more targeting attributes comprise a specification for the one or more web pages and/or one or more demographic elements related to potential users browsing to the one or more web sites.

3. The method of claim 2, wherein the one or more demographic elements comprise one or more of a gender, a location, an age, and an area of interest.

4. The method of claim 1, wherein the plurality of impressions comprise information gathered from a plurality of web page accesses by one or more users, wherein the information gathered from the plurality of web page accesses comprises information related to one or more of user gender, user location, user age, or user area of interest.

5. The method of claim 1, wherein said estimating the available inventory comprises determining how many of one or more previously booked contracts can be satisfied by the sampled impressions based at least in part on one or more targeting attributes of the previously booked contracts

6. The method of claim 5, wherein said determining the capability to fulfill the contract request comprises determining contention between one or more previously booked contracts and the contract request.

7. The method of claim 1, further comprising determining a price for the contract request and reporting a quantity of available impressions.

8. An article, comprising: a storage medium having stored thereon instructions that, if executed, enable a computing platform to:
receive a contract request related to an advertisement to be placed on one or more web pages;
sample a plurality of impressions based, at least in part, on one or more targeting attributes specified in the contract request;
estimate available inventory based at least in part on the sampled plurality of impressions; and
determine a capability to fulfill the contract request based at least in part on the estimated available inventory.

9. The article of claim 8, wherein the one or more targeting attributes comprises a specification for the one or more web pages and/or one or more demographic elements related to potential users browsing to the one or more web sites, wherein the one or more demographic elements comprise one or more of a gender, a location, an age, and an area of interest.

10. The article of claim 8, wherein the contract request comprises a duration for the contract.

11. The article of claim 8, wherein the plurality of impressions comprise information gathered from a plurality of web page accesses by one or more users.

12. The article of claim 11, wherein the information gathered from the plurality of web page accesses comprises information related to one or more of user gender, user location, user age, or user area of interest.

13. The article of claim 8, wherein the storage medium has stored thereon further instructions that, if executed, further enable the computing platform to:
estimate the available inventory by determining how many of one or more previously booked contracts can be satisfied by the sampled impressions based at least in part on one or more targeting attributes of the previously booked contracts; and
determine the capability to fulfill the contract request by determining contention between one or more previously booked contracts and the contract request.

14. The article of claim 8, wherein the storage medium has stored thereon further instructions that, if executed, further enable the computing platform to:
determine a price for the contract request; and
report a quantity of available impressions.

15. An apparatus, comprising: a processor adapted to:
receive a contract request related to an advertisement to be placed on one or more web pages;
sample a plurality of impressions based, at least in part, on one or more targeting attributes specified in the contract request;
estimate available inventory based at least in part on the sampled plurality of impressions; and
determine a capability to fulfill the contract request based at least in part on the estimated available inventory.

16. The apparatus of claim 15, wherein the one or more targeting attributes comprises a specification for the one or more web pages and/or one or more demographic elements related to potential users browsing to the one or more web sites.

17. The apparatus of claim 16, wherein the one or more demographic elements comprise one or more of a gender, a location, an age, and an area of interest.

18. The apparatus of claim 15, wherein the plurality of impressions comprise information gathered from a plurality of web page accesses by one or more users, wherein the information gathered from the plurality of web page accesses comprises information related to one or more of user gender, user location, user age, or user area of interest.

19. The apparatus of claim 15, the processor further adapted to estimate the available inventory by determining how many of one or more previously booked contracts can be satisfied by the sampled impressions based at least in part on one or more targeting attributes of the previously booked contracts.

20. The apparatus of claim 19, the processor further adapted to:
determine the capability to fulfill the contract request by determining contention between one or more previously booked contracts and the contract request;
determine a price for the contract request; and
report a quantity of available impressions.
